(19) United States
(12) Patent Application Publication
(10) Pub. No.: US 2016/0171836 A1
(43) Pub. Date: Jun. 16, 2016

(54) SUPER BLACKJACK GAME

(71) Applicant: Jeffery Hwang, Henderson, NV (US)

(72) Inventor: Jeffery Hwang, Henderson, NV (US)

(21) Appl. No.: 14/703,886

(22) Filed: May 5, 2015

Related U.S. Application Data
(60) Provisional application No. 62/089,860, filed on Dec. 10, 2014.

(51) Int. Cl. G07F 17/32

(52) U.S. Cl. CPC G07F 17/3293; G07F 17/3258

(57) ABSTRACT

A method of a wagering event includes:
a) receiving a wager at a player position;
b) providing the player position with an initial blackjack hand of two playing card symbols;
c) providing a dealer position with two initial playing card symbols;
d) the player position exercising an option between:
   iii. having a player hand competition against dealer cards of either the initial two playing cards or the dealer position taking additional cards to complete a dealer position final hand;
   iv. making a “double-down” wager of between 1× and 5×;
e) splitting the two cards into a first second split hand, placing a split wager equal to the first amount on the second split hand;
f) providing a second random playing card symbol to each of the first and second split hand;
g) the player position standing or doubling down with a double down wager; and
h) resolving all wagers.

### RELATED APPLICATION DATA

This application claims priority from U.S. Provisional Patent Application Ser. No. 62/089,860, filed 10 Dec. 2014.

### BACKGROUND OF THE INVENTION

1. Field of the Invention

The present invention relates to the field of wagering games, wagering games using playing cards as a device for providing a random event outcome, and wagering games using point count outcomes rather than poker outcomes to determine relative strength of hands and outcomes.

2. Background of the Art

The objective of the well known casino table card game of “Twenty-One” or blackjack is for a wagering player to finish a round of play with a hand of playing cards with a sum of the total value of cards coming as close as possible to the value of twenty-one, without the player hand total exceeding twenty-one. The game is played by one or more players against a dealer with the player making an initial wager on a final outcome under the rules of blackjack, which remain fairly consistent throughout the world, and with only minor variations in different casinos or jurisdictions. Players' hands that are less than or equal to twenty-one, and exceed the value of the dealer's hand wins. All players' hands that have a lower sum than the dealer's hand and all hands that exceed the sum of twenty-one lose. Dealer and Player hands with the same total value (without the player first busting) result in ties (called a “push”). An initial two-card hand totaling twenty-one points is called blackjack, and in the absence of the dealer having a similar hand, automatically wins, without respect to the dealer's hand final count and is often paid at odds greater than 1:1.

One conventional method of playing Twenty-One uses one or more standard decks of playing cards (a fifty-two card deck without jokers). Each card is counted according to its face value (Jacks, Queens and Kings are worth 10) and Aces are worth either one (1) or eleven (11), depending on which is most beneficial to the count of the hand. The game begins by dealing two cards to each position where a player has made a wager. The dealer or house is also dealt two cards, usually with on card exposed to view.

A player views an initial value of cards in the player's hand, views the dealer's up-card (the exposed card) and then makes decisions on drawing or not drawing further playing cards. This further drawing is done in an attempt to try and win the hand by having a higher count than the dealer's hand without busting, or allowing the dealer to bust the house hand. The player can “stand” on any count of twenty-one or less. Once the player exceeds a count of twenty-one or “busts,” the player wager is lost, whatever the ultimate point count of the dealer's hand. Usually, the dealer must hit when with a point count of less than seventeen. Normally a dealer must stand on a soft count of at least seventeen, a soft count being a hand value where an Ace is counted as a value of eleven. House rules may vary, however.

Although the game of blackjack or Twenty-one is a consistent winning game for the house, it is always desirable to entice players to increase the size of wagers so that the house wins more money on the house advantage. Players tend to place the minimum wager on a blackjack game unless the player is using some system or feels that the cards are running in a favorable streak.

Numerous methods have been considered for increasing the amount wagered by players on each hand or round of play in blackjack and other games. Side bets and jackpot wagers have been introduced, but these establish separate wagering pots or have their own distinct advantage and do not increase the amount of the wager on the underlying game. In fact, side bets tend to cause players to place minimum wagers because the odds in payouts are larger in the jackpot and side bet games, even if the frequency of wins may be less.

Other game designs have attempted to increase wagers from players on single rounds of play by providing players with multiple hands. This has been especially true in video blackjack games, with such disclosures as the following indicating the use of multiple players hands against a single dealer hand (e.g., U.S. Pat. Nos. 5,954,335; 5,531,448; and 5,732,950; and U.S. Patent Publication 20030090063) or multiple dealer hands (e.g., U.S. Pat. Nos. 6,959,927 and 5,154,429).

Other disclosures provide multiple player hands in live casino table blackjack game variants. These formats could also be used for video blackjack. Other formats of play vary the rules of the game to give an appearance of a differing relative advantage between a player and a dealer to attract larger wagers and longer play duration at the table.

U.S. Pat. No. 5,322,295 describes methods of playing card games wherein a player makes a plurality of wagers and is provided with an initial partial card hand for each wager. The player receives additional cards which the player assigns to the previously received initial partial hands. The supplemental cards provided to a player can be provided to the player all at once or one at a time. One specific method of play comprises the steps of: a) a player making at least two separate wagers; b) a dealer providing said player with at least one card for each wager made by said player and assigning said card to said wagers such that each wager has been assigned an initial partial hand; c) the dealer providing each player with a first supplemental card which said player may assign to one of said initial partial hands; and d) the dealer providing at least one additional supplemental card which the dealer assigns to an initial partial hand which has not yet been assigned a supplemental card by the player.

U.S. Pat. No. 6,481,717 (Richardelle) discloses a method of playing a card game by dealing a first hand consisting of a first predetermined number of cards. The method requires one or more players to elect whether or not to play a second hand. Each of the first hands are compared to determine whether or not they constitute a winning hand. A second hand consisting of a second predetermined number of cards is dealt. The first cards from the first hand are included in the second hand. Each of the second hands are compared using a predetermined ranking as a criterion for comparison to determine a winning hand. Each player who had a winning first hand and/or a winning second hand is then designated a winner. The first predetermined number of cards consists of two cards, and the first hand is played as a blackjack hand. The second predetermined number of cards consists of a number of cards, in addition to the cards drawn by each player for the blackjack hand, to make up a poker hand. Each player is required to place a bet before each step of dealing the first and second hands, and they are paid after the step of designating winning players. Such step of paying the winning player(s) includes the step of paying the winning player according to the odds set forth in a predetermined table depending upon the poker rank of the winning hand(s).

U.S. Pat. No. 7,036,821 (Hall) describes a card game with a set of playing cards and a gaming cloth (10), the gaming cloth (10) defining an area (12) in which a dealer may deal two or more cards constituting a house hand, and a plurality of player areas. Each player area includes an area (14, 16) in which two or more hands comprised of two or more cards may be dealt to a player; areas (18, 20) corresponding to each hand for placing a bet on the hands beating the house hand; and an area (22) in which optional bets may be placed on the matching of the cards dealt to each player to specified hands. The game may provide multiple hands to a player, and a wager in addition to the wagers on each of the two hands.

U.S. Pat. No. 5,280,915 (Groussman) describes a method of playing a blackjack game that enables a blackjack player to make a second initial wager and play a second initial hand on any deal of the cards. The layout of the table includes boxes on each player station where the wagers are placed, and card dealing areas next to each of the boxes where the hands of cards are dealt. With this layout, the dealer and player can clearly determine which cards belongs to the player's first wager and which cards belong to the player's second wager.

There is an on-line twenty-one variant referred to as Caribbean-21 Blackjack™ game.

http://bettingonblackjack.com/blackjack-variants/caribbean-21-blackjack/

Each online casino might use different software and therefore the rules of Caribbean 21 blackjack can be different for each online casino. So make sure that you become familiar with the standard rules that we discuss here and always read the rules of the online casino of your choice.

Some websites may appear to say that the player can split any two cards.

http://wizardofodds.com/games/caribbean-21/
http://www.hundredpercentgambling.com/page.php?pid=Caribbean %2021

In Caribbean 21 Blackjack 8 decks of 52 cards are being used. All the card values are the same as in Classic Blackjack with one big exception: the Ace will only count as 1, it is a hard Ace.

The game will begin when the players makes the initial bet, he or she will then be dealt two cards which are face up. The dealer will only receive one card which is also face up. There is no hole card at Caribbean 21 blackjack. First the player has to decide what he/she will do. The player can do the same as in classic blackjack: hit, stand, split or double. The player is allowed to double at any time with two or more cards. There is also the possibility to double or redouble after a split. A split can be done on any two of the same cards and also after a previous split. Aces are seen as only one value and therefore they are treated the same as any other card so you can also split these without consequences.

The player also has the option to surrender at any time during the round, and will lose half of the bet.

When the player is finished with your hand the dealer will receive a second card. Based on the outcome of that second card the outcome of the game is determined. The highest possible hand that the player can get at Caribbean 21 blackjack is a Caribbean 21. This consists of an Ace and two 10 valued cards. A Caribbean 21 is ranked higher than any other 21 point hand.

### Published Specifications of Caribbean-21™ Blackjack

Caribbean 21 blackjack has some other rules than the standard blackjack. Always check out the rules on the website of the online casino that you want to play because the rules of Caribbean 21 can differ per online casino. Below we will list some of the most standard specifications of Caribbean 21 blackjack.
An ace is counted as a hard card and never as a soft card, therefore the Ace will only count as 1 point at Caribbean 21 blackjack.
The highest hand possible is a Caribbean 21 and consists of an Ace and two 10-valued cards. It will pay out 3:2.
Surrendering can be done at any moment.
You can split any two of the same cards.
Doubling is allowed at any time with either two or more hands. After a split it is also allowed to double or redouble. Splitting Aces has no consequences.
There is no hole card as the dealers cards are also dealt face up.
The dealer will win all ties.
When the dealers first card is an Ace you can buy insurance. The payout in insurance is 9:1.

### SUMMARY OF THE INVENTION

A method of engaging in a wagering event includes:
a) receiving a wager at a player position;
b) providing the player position with an initial blackjack hand of two playing card symbols;
c) providing a dealer position with two initial playing card symbols;
d) the player position exercising an option between:
   i) having a player hand competition against dealer cards of either the initial two playing cards or the dealer position taking additional cards to complete a dealer position final hand;
   ii) splitting the two cards into a first split hand and a second split hand, placing a split wager equal to the first amount on the second split hand;
   iii) providing a second random playing card symbol to each of the first split hand and the second split hand;
e) the player position either standing or doubling down with a double down wager; and
f) resolving all wagers.

### BRIEF DESCRIPTION OF THE FIGURES

FIG. 1 shows an electronic gaming table on which the gaming method may be executed.

FIG. 1A shows a schematic for an electronic system for enabling play of the gaming method described herein.

FIG. 1B shows another schematic for an electronic system for enabling play of the gaming method described herein.

### DETAILED DESCRIPTION OF THE INVENTION

A method of a wagering event referred to as “Super Blackjack”™ game includes:
a) receiving a wager at a player position;
b) providing the player position with an initial blackjack hand of two playing card symbols;
c) providing a dealer position with two initial playing card symbols;
d) the player position exercising an option between:
   i. having a player hand competition against dealer cards of either the initial two playing cards or the dealer position taking additional cards to complete a dealer position final hand;
   ii. making a “double-down” wager of between 1× and 5×;
e) splitting the two cards into a first second split hand, placing a split wager equal to the first amount on the second split hand;
f) providing a second random playing card symbol to each of the first and second split hand;
g) the player position standing or doubling down with a double down wager; and
h) resolving all wagers.
   Super Blackjack™ game general disclosure

The methodology and strategies in this game allows more aggressive strategies, higher intermediate wagers and yet still maintains the flavor of traditional blackjack, so the game can be quickly learned and understood. Players can split and double down on any hand.

Super Blackjack plays like traditional Blackjack with the following alterations:

Players and dealer are dealt two cards each, player cards preferably dealt face-up, and the dealer cards dealt one face-up and one face-down. Players cannot hit their initial two-card hand. They either stay with their original cards; double down and elect from 1×, 2×, 3× or 4× (possibly more) of the initial wager as the double-down amount; or split their initial two-card hand into two one-card hands which each receive a split-completing second card at each hand, either in one step, or sequentially (one hand at a time, with each hand being completed according to limitations on steps).

Players can split any two cards for 1× their initial wager, leaving equal value initial wagers on two hands. Players either keep their two split hands “as-is” or either or both hands may be played as a double-down, and the player may elect from 1×, 2×, 3× or 4× (possibly more) of the initial wager as the double-down wager amount. Thus, Players can double down on any two cards for between 1× and 4× their initial wager.

If a player splits his hand, player can opt to double down on one or both of the split hands for between 1× and 4× the wager for each hand. If there is no double down on a split hand, that hand plays “as-is” with the two cards and the initial wager amount.

If a player splits his hand and a split hand contains a pair, the player may re-split.

There are possible variations in the play of this relatively simple game:

A surrender option may be possible under certain conditions. (e.g., at the usual one-half of the initial wager, with odd dollar amounts probably rounded down, so that an surrender on a $10 wager would be a $5 return, and a surrender with a $5 wager could be $2.50 if half unit coinage/chips are available, or only $2.00.

It may be possible to create a version where players can re-split a certain hand (such as AA). A natural 21 may pay more than the standard 3 to 2, such as 2:1. It's possible that a split that hits blackjack can pay better odds than 1:1 as is normally done on a winning blackjack hand. It might pay amounts such as 3 to 2 or even 2:1. Another variation may give players a bonus payout if their double down produces a total of exactly 21 (such as 50% increase in the wagered amount or double the wagered amount, this bonus preferably NOT being applied when a double-down wager amount.

The method technology may be more specifically described as a method of engaging in a wagering event including:
a) receiving a wager of a first amount at a player position;
b) providing a random set of playing card symbols;
c) providing the player position with an initial hand of exactly two playing card symbols from the random set of playing cards;
d) providing a dealer position with exactly two initial playing card symbols;
e) the player position exercising an option between three steps:
   i) keeping the initial two playing card symbols in a competition against dealer position cards of either the initial two playing cards or the dealer position taking additional cards to complete a dealer position final hand with a point count total of at least 17;
   ii) making a “double down” wager between 1× and 5× the initial wager, and drawing exactly one card;
   iii) splitting the two cards into a first split hand and a second split hand, placing a split wager equal to the first amount on the second split hand;
f) providing a second random playing card symbol to each of the first split hand and the second split hand, forming a two-card first split hand and a two-card second split hand;
g) the player position either standing with neither, one or both of the a two-card first split hand and a two-card second split hand, or placing a double-down wager on neither, one or both of the two-card first split hand and the two-card second split hand, the double down wager being in an amount equal to or greater than the first amount wagered at the player position; and
h) resolving all wagers for all hands at the player position based on a comparison of blackjack hand ranks for all hands at the player position against a blackjack hand rank at the dealer position for a final dealer position final hand rank.

The playing card symbols may be provided with physical cards from a device that provides random playing cards from a set of playing cards, such as from a device selected from the group consisting of a delivery shoe and a playing card randomization apparatus. The double down wager is selected from the group consisting of 1×, 2×, 3×, 4× and 5× the first amount wagered at the player position. The dealer position final hand may be completed by the dealer position taking required additional random card symbols to complete a dealer position final hand with a point count total of at least a hard 17 or at least a soft 17.

### Super Blackjack™ (Version X): 2 Forced (Mandatory) Bets

This is one preferred variation, known simply as Super Blackjack™ game. This version starts with two forced or mandatory bets:
1) A standard Game wager and
2) An equal Ante wager, which pays according to a paytable when the dealer busts.

In this version, the player can split any two cards (whether paired in rank or not, and the first two cards only) and “double” down for more than 1:1 times the initial Game wager, for example up to 4× his initial Game wager or even more. There is no hitting—the player must stand, split, or double down (i.e., pay to draw a single card).

### Additionally:

Blackjack pays 2 to 1
The player can double down after split for 1:1 or more, for example up to 4× or more
The player can re-split pairs any number of times
The game is dealt from six decks preferably with a continuous shuffler
The dealer must hit soft 17; in another variation, the dealer may stand all 17s

### The Ante

The forced Ante wager must be equal in size to the standard Game wager. If the player busts, the player forfeits the Ante wager; otherwise, the Ante wager pays according to a paytable when the dealer busts. The payout varies depending on whether the dealer hits soft 17 or stands on all 17s. In the preferred variation, the dealer hits soft 17.

### Ante Paytable

| Dealer Final | Payout (Dealer | Payout (Dealer |
|---|---|---|
| Hand Total | Hits Soft 17) | Stands on All 17s) |
| 17-21 | Loss | Loss |
| 26 | 4:1 | 3:1 |
| 25 | 2:1 | 3:1 |
| 24 | 3:2 | 3:2 |
| 23 | 1:1 | 1:1 |
| 22 | 1:1 | 1:1 |

### Super Blackjack Version Y™ Game: Single-Bet Variation

Super Blackjack Version Y™ is a single-bet variation, in which the player only begins with a standard initial Game wager. In this version:
The player may split any initial two-card hand containing an Ace or any deuce; in another variation, the player may split an initial two-card hand containing a three as well
The player may “double down” (i.e., make a wager and draw exactly one card) for 1:1 or more, for example up to 3× his initial game wager or more
The player may re-split pairs any number of times

This version has an optional Bust the Dealer™ sidebet, which pays according to a paytable when the dealer busts, and loses when the dealer does not bust. This wager is separate from the main game; thus, if the player busts, this wager does not lose.

### Bust the Dealer Paytable

| Dealer Final | Payout (Dealer | Payout (Dealer |
|---|---|---|
| Hand Total | Hits Soft 17) | Stands on All 17s) |
| 17-21 | Loss | Loss |
| 26 | 5:1 | 5:1 |
| 25 | 2:1 | 4:1 |
| 24 | 2:1 | 2:1 |
| 23 | 2:1 | 2:1 |
| 22 | 2:1 | 1:1 |

The random playing card symbols may alternatively be provided by a processor having a random number generator, and virtual playing card symbols, and then displayed on a display device, the processor and display device contained in a housing, and wagers and playing card activity on player hands is directed through a player input system.

The virtual method may be played wherein each of the player position exactly the correct number of initial cards in a player position hand and the dealer position exactly the correct number of virtual cards for a dealer position hand. These are initially virtually dealt to each of the player position and the dealer position or wherein each of the player position exactly correct number of virtual playing cards in the player hand and the dealer position exactly correct number of virtual playing cards in the dealer/banker hand are initially virtually dealt to and displayed at each of the player position and the dealer position as exactly the correct number of virtual playing cards each and third virtual cards are virtually delivered from the randomized set of virtual playing cards upon demand for any further virtual playing cards at each of the player position and the dealer position.

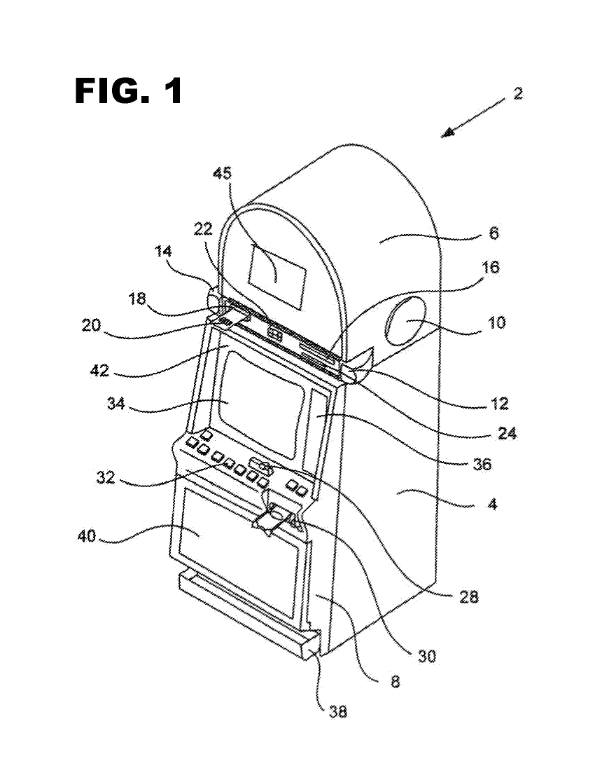

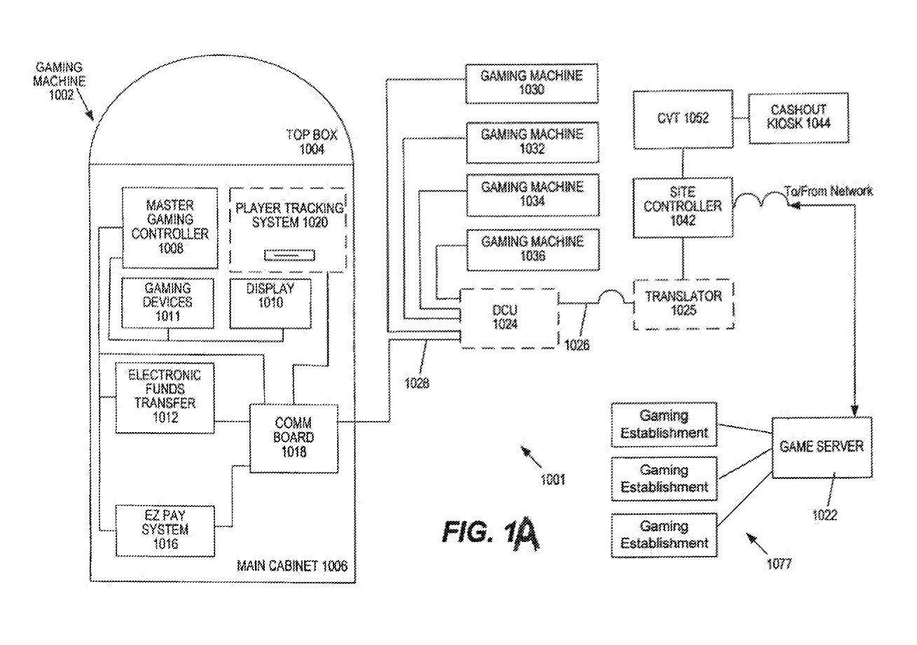

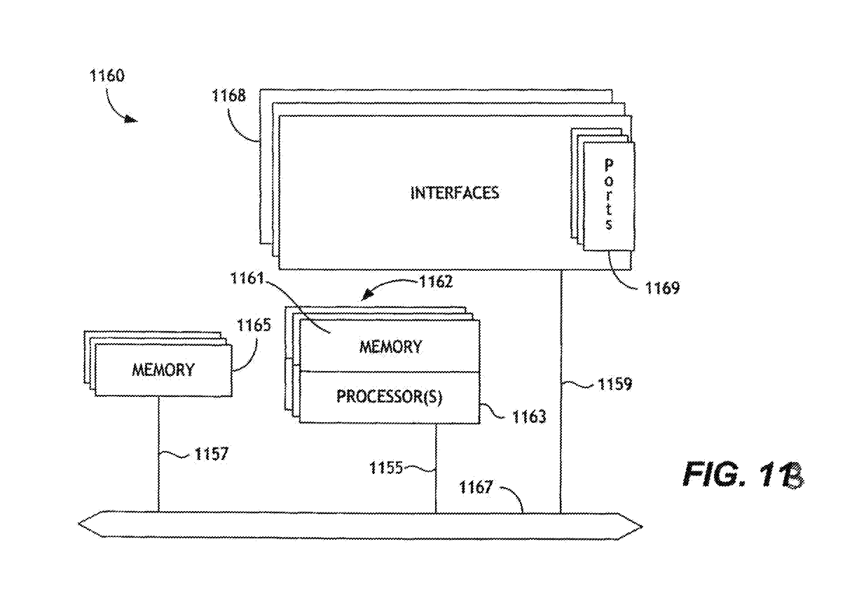

Turning next to FIG. 1, a video gaming machine 2 that may be used as the underlying base gaming counsel of the present invention is shown. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a display area including a mechanical gaming system (or less preferably a separate electronic game) 40. There may be an overlay of touchscreen functionality on the separate electronic game 40 or some of the buttons 32 may be functional on the separate mechanical gaming system 40. That separate mechanical gaming system may be in a relatively vertical viewing position as shown or in a more horizontal (table like) display unit. Viewable through the main door is a video display monitor 34 and an information panel 36. The display monitor 34 will typically be a cathode ray tube, high resolution flat-panel LCD, LED, plasma screen or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. The devices are controlled by circuitry (e.g. the master gaming controller) housed inside the main cabinet 4 of the machine 2.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

The gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 6 may house different or additional devices than shown in the FIG. 1. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 4 of the machine 2.

Understand that gaming machine 2 is but one example from a wide range of gaming machine designs on which the present invention may be implemented. For example, not all suitable gaming machines have top boxes or player tracking features. Further, some gaming machines have only a single game display—mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

Gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modem general-purpose computers include voltage monitoring circuitry, these types of circuits only report voltage status to the operating software. Out of tolerance voltages can cause software malfunction, creating a potential uncontrolled condition in the gaming computer. Gaming machines typically have power supplies with tighter voltage margins than that required by the operating circuitry. In addition, the voltage monitoring circuitry implemented in gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc. that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, such as gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, the Netplex™ system of IGT is a proprietary communication protocol used for serial communication between gaming devices. As another example, SAS is a communication protocol used to transmit information, such as metering information, from a gaming machine to a remote device. Often SAS is used in conjunction with a player tracking system.

Gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into a gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in a gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 titled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 1, when a user wishes to play the gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 42 located in the top box.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights within the separate mechanical (or electronic) separately, individually wagerable gaming system 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

Another gaming network that may be used to implement some aspects of the invention is depicted in FIG. 1A. Gaming establishment 1001 could be any sort of gaming establishment, such as a casino, a card room, an airport, a store, etc. In this example, gaming network 1077 includes more than one gaming establishment, all of which are networked to game server 1022. Here, gaming machine 1002, and the other gaming machines 1030, 1032, 1034, and 1036, include a main cabinet 1006 and a top box 1004. The main cabinet 1006 houses the main gaming elements and can also house peripheral systems, such as those that utilize dedicated gaming networks. The top box 1004 may also be used to house these peripheral systems.

The master gaming controller 1008 controls the game play on the gaming machine 1002 according to instructions and/or game data from game server 1022 or stored within gaming machine 1002 and receives or sends data to various input/output devices 1011 on the gaming machine 1002. In one embodiment, master gaming controller 1008 includes processor(s) and other apparatus of the gaming machines described above. The master gaming controller 1008 may also communicate with a display 1010.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 1008 may also communicate with EFT system 1012, EZPay™ system, and player tracking system 1020. The systems of the gaming machine 1002 communicate the data onto the network 1022 via a communication board 1018.

It will be appreciated by those of skill in the art that embodiments of the present invention could be implemented on a network with more or fewer elements than are depicted in FIG. 1A. For example, player tracking system 1020 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Player tracking information may be combined with other information that is now readily obtainable by an SBG system.

Moreover, DCU 1024 and translator 1025 are not required for all gaming establishments 1001. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 1042 provides this function for gaming establishment 1001. Site controller 1042 is connected to a central system and/or other gaming establishments via one or more networks, which may be public or private networks. Among other things, site controller 1042 communicates with game server 1022 to obtain game data, such as ball drop data, bingo card data, etc.

In the present illustration, gaming machines 1002, 1030, 1032, 1034 and 1036 are connected to a dedicated gaming network 1022. In general, the DCU 1024 functions as an intermediary between the different gaming machines on the network 1022 and the site controller 1042. In general, the DCU 1024 receives data transmitted from the gaming machines and sends the data to the site controller 1042 over a transmission path 1026. In some instances, when the hardware interface used by the gaming machine is not compatible with site controller 1042, a translator 1025 may be used to convert serial data from the DCU 1024 to a format accepted by site controller 1042. The translator may provide this conversion service to a plurality of DCUs.

Further, in some dedicated gaming networks, the DCU 1024 can receive data transmitted from site controller 1042 for communication to the gaming machines on the gaming network. The received data may be, for example, communicated synchronously to the gaming machines on the gaming network.

Here, CVT 1052 provides cashless and cashout gaming services to the gaming machines in gaming establishment 1001. Broadly speaking, CVT 1052 authorizes and validates cashless gaming machine instruments (also referred to herein as “tickets” or “vouchers”), including but not limited to tickets for causing a gaming machine to display a game result and cash-out tickets. Moreover, CVT 1052 authorizes the exchange of a cashout ticket for cash. These processes will be described in detail below. In one example, when a player attempts to redeem a cash-out ticket for cash at cashout kiosk 1044, cash out kiosk 1044 reads validation data from the cashout ticket and transmits the validation data to CVT 1052 for validation. The tickets may be printed by gaming machines, by cashout kiosk 1044, by a stand-alone printer, by CVT 1052, etc. Some gaming establishments will not have a cashout kiosk 1044. Instead, a cashout ticket could be redeemed for cash by a cashier (e.g. of a convenience store), by a gaming machine or by a specially configured CVT.

FIG. 1B illustrates an example of a network device that may be configured for implementing some methods of the present invention. Network device 1160 includes a master central processing unit (CPU) 1162, interfaces 1168, and a bus 1167 (e.g., a PCI bus). Generally, interfaces 1168 include ports 1169 appropriate for communication with the appropriate media. In some embodiments, one or more of interfaces 1168 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1168 control such communications-intensive tasks as encryption, decryption, compression, decompression, packetization, media control and management. By providing separate processors for the communications-intensive tasks, interfaces 1168 allow the master microprocessor 1162 efficiently to perform other functions such as routing computations, network diagnostics, security functions, etc.

The interfaces 1168 are typically provided as interface cards (sometimes referred to as “linecards”). Generally, interfaces 1168 control the sending and receiving of data packets over the network and sometimes support other peripherals used with the network device 1160. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1162 may be responsible for implementing specific functions associated with the functions of a desired network device. According to some embodiments, CPU 1162 accomplishes all these functions under the control of software including an operating system and any appropriate applications software.

CPU 1162 may include one or more processors 1163 such as a processor from the Motorola family of microprocessors or the MIPS family of microprocessors. In an alternative embodiment, processor 1163 is specially designed hardware for controlling the operations of network device 1160. In a specific embodiment, a memory 1161 (such as non-volatile RAM and/or ROM) also forms part of CPU 1162. However, there are many different ways in which memory could be coupled to the system. Memory block 1161 may be used for a variety of purposes such as, for example, caching and/or storing data, programming instructions, etc.

Regardless of network device's configuration, it may employ one or more memories or memory modules (such as, for example, memory block 1165) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 1B illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 1B) or switch fabric based (such as a cross-bar).

The CPU system may perform additional functions unique to the operation of the present gaming system. The CPU may be engaged with flow meters to measure rates or flow of liquid, volume of total water in the system (by measuring volume in the reservoir when a lowest amount of fluid is in the container and pipes, determination of proportionate payouts dependent upon fluid levels and execution of unique game code. A densitometer in the fluid flow path may be present to determine deterioration in color density or discoloration of the fluid due to contamination, and an alarm is sounded when the color quality (density, tone, wavelengths of absorption and the like) varies beyond predetermined parameters.

Those skilled in the gaming and video gaming arts will be aware of the availability of existing and improving technology that may be used as alternatives within the generic concepts enabled herein in the practice of the present invention. Among such changes could be:

The player must make a wager of 1×-5× the initial wager in order to continue, or otherwise fold and forfeit his initial wager (i.e., bet-or-fold), and if the player makes a wager, he may either stand (make a standard waving motion); split; or hit and draw exactly one card (i.e., double down), and if the player splits, the player can stand (no additional wager required), or bet 1×-5× the initial wager and draw exactly one card.

The random playing card symbols may alternatively be provided by a processor having a random number generator, and virtual playing card symbols, and then displayed on a display device, the processor and display device contained in a housing, and wagers and playing card activity on player hands is directed through a player input system.

The virtual method may be played wherein each of the player position exactly the correct number of initial cards in a player position hand and the dealer position exactly the correct number of virtual cards for a dealer position hand. These are initially virtually dealt to each of the player position and the dealer position or wherein each of the player position exactly correct number of virtual playing cards in the player hand and the dealer position exactly correct number of virtual playing cards in the dealer/banker hand are initially virtually dealt to and displayed at each of the player position and the dealer position as exactly the correct number of virtual playing cards each and third virtual cards are virtually delivered from the randomized set of virtual playing cards upon demand for any further virtual playing cards at each of the player position and the dealer position.

Turning next to FIG. 1, a video gaming machine 2 that may be used as the underlying base gaming counsel of the present invention is shown. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a display area including a mechanical gaming system (or less preferably a separate electronic game) 40. There may be an overlay of touchscreen functionality on the separate electronic game 40 or some of the buttons 32 may be functional on the separate mechanical gaming system 40. That separate mechanical gaming system may be in a relatively vertical viewing position as shown or in a more horizontal (table like) display unit. Viewable through the main door is a video display monitor 34 and an information panel 36. The display monitor 34 will typically be a cathode ray tube, high resolution flat-panel LCD, LED, plasma screen or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. The devices are controlled by circuitry (e.g. the master gaming controller) housed inside the main cabinet 4 of the machine 2.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality′ of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

The gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 6 may house different or additional devices than shown in the FIG. 1. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 4 of the machine 2.

Understand that gaming machine 2 is but one example from a wide range of gaming machine designs on which the present invention may be implemented. For example, not all suitable gaming machines have top boxes or player tracking features. Further, some gaming machines have only a single game display—mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

Gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modem general-purpose computers include voltage monitoring circuitry, these types of circuits only report voltage status to the operating software. Out of tolerance voltages can cause software malfunction, creating a potential uncontrolled condition in the gaming computer. Gaming machines typically have power supplies with tighter voltage margins than that required by the operating circuitry. In addition, the voltage monitoring circuitry implemented in gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc. that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, such as gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, ETA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, the Netplex™ system of IGT is a proprietary communication protocol used for serial communication between gaming devices. As another example, SAS is a communication protocol used to transmit information, such as metering information, from a gaming machine to a remote device. Often SAS is used in conjunction with a player tracking system.

Gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into a gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in a gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 titled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 1, when a user wishes to play the gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 42 located in the top box.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights within the separate mechanical (or electronic) separately, individually wagerable gaming system 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

Another gaming network that may be used to implement some aspects of the invention is depicted in FIG. 1A. Gaming establishment 1001 could be any sort of gaming establishment, such as a casino, a card room, an airport, a store, etc. In this example, gaming network 1077 includes more than one gaming establishment, all of which are networked to game server 1022. Here, gaming machine 1002, and the other gaming machines 1030, 1032, 1034, and 1036, include a main cabinet 1006 and a top box 1004. The main cabinet 1006 houses the main gaming elements and can also house peripheral systems, such as those that utilize dedicated gaming networks. The top box 1004 may also be used to house these peripheral systems.

The master gaming controller 1008 controls the game play on the gaming machine 1002 according to instructions and/or game data from game server 1022 or stored within gaming machine 1002 and receives or sends data to various input/output devices 1011 on the gaming machine 1002. In one embodiment, master gaming controller 1008 includes processor(s) and other apparatus of the gaming machines described above. The master gaming controller 1008 may also communicate with a display 1010.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 1008 may also communicate with EFT system 1012, EZPay™ system, and player tracking system 1020. The systems of the gaming machine 1002 communicate the data onto the network 1022 via a communication board 1018.

It will be appreciated by those of skill in the art that embodiments of the present invention could be implemented on a network with more or fewer elements than are depicted in FIG. 1A. For example, player tracking system 1020 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Player tracking information may be combined with other information that is now readily obtainable by an SBG system.

Moreover, DCU 1024 and translator 1025 are not required for all gaming establishments 1001. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 1042 provides this function for gaming establishment 1001. Site controller 1042 is connected to a central system and/or other gaming establishments via one or more networks, which may be public or private networks. Among other things, site controller 1042 communicates with game server 1022 to obtain game data, such as ball drop data, bingo card data, etc.

In the present illustration, gaming machines 1002, 1030, 1032, 1034 and 1036 are connected to a dedicated gaming network 1022. In general, the DCU 1024 functions as an intermediary between the different gaming machines on the network 1022 and the site controller 1042. In general, the DCU 1024 receives data transmitted from the gaming machines and sends the data to the site controller 1042 over a transmission path 1026. In some instances, when the hardware interface used by the gaming machine is not compatible with site controller 1042, a translator 1025 may be used to convert serial data from the DCU 1024 to a format accepted by site controller 1042. The translator may provide this conversion service to a plurality of DCUs.

Further, in some dedicated gaming networks, the DCU 1024 can receive data transmitted from site controller 1042 for communication to the gaming machines on the gaming network. The received data may be, for example, communicated synchronously to the gaming machines on the gaming network.

Here, CVT 1052 provides cashless and cashout gaming services to the gaming machines in gaming establishment 1001. Broadly speaking, CVT 1052 authorizes and validates cashless gaming machine instruments (also referred to herein as “tickets” or “vouchers”), including but not limited to tickets for causing a gaming machine to display a game result and cash-out tickets. Moreover, CVT 1052 authorizes the exchange of a cashout ticket for cash. These processes will be described in detail below. In one example, when a player attempts to redeem a cash-out ticket for cash at cashout kiosk 1044, cash out kiosk 1044 reads validation data from the cashout ticket and transmits the validation data to CVT 1052 for validation. The tickets may be printed by gaming machines, by cashout kiosk 1044, by a stand-alone printer, by CVT 1052, etc. Some gaming establishments will not have a cashout kiosk 1044. Instead, a cashout ticket could be redeemed for cash by a cashier (e.g. of a convenience store), by a gaming machine or by a specially configured CVT.

FIG. 1B illustrates an example of a network device that may be configured for implementing some methods of the present invention. Network device 1160 includes a master central processing unit (CPU) 1162, interfaces 1168, and a bus 1167 (e.g., a PCI bus). Generally, interfaces 1168 include ports 1169 appropriate for communication with the appropriate media. In some embodiments, one or more of interfaces 1168 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1168 control such communications-intensive tasks as encryption, decryption, compression, decompression, packetization, media control and management. By providing separate processors for the communications-intensive tasks, interfaces 1168 allow the master microprocessor 1162 efficiently to perform other functions such as routing computations, network diagnostics, security functions, etc.

The interfaces 1168 are typically provided as interface cards (sometimes referred to as “linecards”). Generally, interfaces 1168 control the sending and receiving of data packets over the network and sometimes support other peripherals used with the network device 1160. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1162 may be responsible for implementing specific functions associated with the functions of a desired network device. According to some embodiments, CPU 1162 accomplishes all these functions under the control of software including an operating system and any appropriate applications software.

CPU 1162 may include one or more processors 1163 such as a processor from the Motorola family of microprocessors or the MIPS family of microprocessors. In an alternative embodiment, processor 1163 is specially designed hardware for controlling the operations of network device 1160. In a specific embodiment, a memory 1161 (such as non-volatile RAM and/or ROM) also forms part of CPU 1162. However, there are many different ways in which memory could be coupled to the system. Memory block 1161 may be used for a variety of purposes such as, for example, caching and/or storing data, programming instructions, etc.

Regardless of network device's configuration, it may employ one or more memories or memory modules (such as, for example, memory block 1165) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 1B illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 1B) or switch fabric based (such as a cross-bar).

The CPU system may perform additional functions unique to the operation of the present gaming system.

Those skilled in the gaming and video gaming arts will be aware of the availability of existing and improving technology that may be used as alternatives within the generic concepts enabled herein in the practice of the present invention. Among such changes could be additional side bet wagers, specialty cards added to the original set of playing cards, and the like.

What is claimed:

1. A method of engaging in a wagering event comprising:
a) receiving a wager of a first amount at a player position on a gaming table;
b) providing a random set of playing card symbols;
c) providing the player position with an initial hand of exactly two playing card symbols from the random set of playing cards;
d) providing a dealer position with exactly two initial playing card symbols;
e) the player position exercising an option between two steps:
i) keeping the initial two playing card symbols in a competition against dealer position cards of either the initial two playing cards or the dealer position taking additional cards to complete a dealer position final hand with a point count total of at least 17;
ii) making a “double down” wager between 1× and 5× the initial wager, and drawing exactly one card;
iii) splitting the two cards into a first split hand and a second split hand, placing a split wager equal to the first amount on the second split hand;
f) providing a second random playing card symbol to each of the first split hand and the second split hand, forming a two-card first split hand and a two-card second split hand;
g) the player position either standing with neither, one or both of the a two-card first split hand and a two-card second split hand, or placing a double-down wager on neither, one or both of the two-card first split hand and the two-card second split hand, the double down wager being in an amount equal to or greater than the first amount wagered at the player position; and
h) resolving all wagers for all hands at the player position based on a comparison of blackjack hand ranks for all hands at the player position against a blackjack hand rank at the dealer position for a final dealer position final hand rank.

2. The method of claim 1 wherein the playing card symbols are provided with physical cards from a device that provides random playing cards from a set of playing cards.

3. The method of claim 2 wherein the physical playing cards are provided from a device selected from the group consisting of a delivery shoe and a playing card randomization apparatus.

4. The method of claim 2 wherein the double down wager is selected from the group consisting of 1×, 2×, 3×, 4× and 5× the first amount wagered at the player position.

5. The method of claim 1 wherein the dealer position final hand is completed by the dealer position taking required additional random card symbols to complete a dealer position final hand with a point count total of at least a hard 17.

6. The method of claim 2 wherein the player position places a side bet wager against a paytable at a dedicated side bet location on the gaming table, the side bet won by the player position only when the dealer position hand busts and the player hand hasn't busted.

7. The method of claim 3 wherein the player position places a side bet wager against a paytable at a dedicated side bet location on the gaming table, the side bet won by the player position only when the dealer position hand busts and the player hand hasn't busted.

8. The method of claim 4 wherein the player position places a side bet wager against a paytable at a dedicated side bet location on the gaming table, the side bet won by the player position only when the dealer position hand busts and the player hand hasn't busted.

9. The method of claim 1 wherein the random playing card symbols are provided by a processor having a random number generator, and virtual playing card symbols, and then displayed on a display device, the processor and display device contained in a housing, and wagers and playing card activity on player hands is directed through a player input system.

10. The method of claim 9 wherein the double down wager is selected from the group consisting of 1×, 2×, 3×, 4× and 5× the first amount wagered at the player position.

11. The method of claim 9 wherein the dealer position final hand is completed by the dealer position taking required additional random card symbols to complete a dealer position final hand with a point count total of at least a hard 17.

12. The method of claim 10 wherein the player position places a side bet wager against a paytable using a dedicated player input control on the housing, the side bet won by the player position only when the dealer position hand busts and the player hand hasn't busted.

13. The method of claim 9 wherein the dealer position final hand is completed by the dealer position taking required additional random card symbols to complete a dealer position final hand with a point count total of at least a soft 17.

14. The method of claim 10 wherein the player position places a side bet wager against a paytable using a dedicated player input control on the housing, the side bet won by the player position only when the dealer position hand busts and the player hand hasn't busted.

15. A method of engaging in a wagering event comprising:
a) receiving a wager of a first amount at a player position;
b) providing a random set of playing card symbols;
c) providing the player position with an initial hand of exactly two playing card symbols from the random set of playing cards;
d) providing a dealer position with exactly two initial playing card symbols;
e) the player position exercising a selection of steps among at least three steps selected from the group consisting of:
i. keeping the initial two playing card symbols in a competition against dealer position cards of either the initial two playing cards or the dealer position taking additional cards to complete a dealer position final hand with a point count total of at least 17;
ii. making a double down wager at least equal to the first amount wagered and receiving one additional playing card symbol to add to the initial two playing card symbols forming a three card hand in a competition against dealer position cards of either the initial two playing cards or the dealer position taking additional cards to complete a dealer position final hand with a point count total of at least 17; and
iii. splitting the two cards into a first split hand and a second split hand, placing a split wager equal to the first amount on the second split hand;
f) providing a second random playing card symbol to each of the first split hand and the second split hand, forming a two-card first split hand and a two-card second split hand;
g) the player position either standing with neither, one or both of the a two-card first split hand and a two-card second split hand, or placing a double-down wager on neither, one or both of the two-card first split hand and the two-card second split hand, the double down wager being in an amount equal to or greater than the first amount wagered at the player position; and
h) resolving all wagers for all hands at the player position based on a comparison of blackjack hand ranks for all hands at the player position against a blackjack hand rank at the dealer position for a final dealer position final hand rank.

16. The method of claim 15 wherein the playing card symbols are provided with physical cards from a device that provides random playing cards from a set of playing cards.

17. The method of claim 16 wherein the physical playing cards are provided from a device selected from the group consisting of a delivery shoe and a playing card randomization apparatus.

18. The method of claim 16 wherein the double down wager is selected from the group consisting of 1×, 2×, 3×, 4× and 5× the first amount wagered at the player position.

19. The method of claim 16 wherein the random playing card symbols are provided by a processor having a random number generator, and virtual playing card symbols, and then displayed on a display device, the processor and display device contained in a housing, and wagers and playing card activity on player hands is directed through a player input system.

20. The method of claim 15 wherein the player position places a side bet wager against a paytable using a dedicated player input control on the housing, the side bet won by the player position only when the dealer position hand busts and the player hand hasn't busted.

21. The method of claim 3 wherein the player position places a side bet wager against a paytable using a dedicated player input control on the housing, the side bet won by the player position only when the dealer position hand busts, whether or not the player hand has busted.
